(19) United States
(12) Patent Application Publication
(10) Pub. No.: US 2019/0143465 A1
(43) Pub. Date: May 16, 2019

(54) MACHINE TOOL AND METHOD OF CONTROLLING MACHINE TOOL

(71) Applicant: FANUC CORPORATION, Yamanashi (JP)

(72) Inventor: Akihiko Nagao, Yamanashi-ken (JP)

(73) Assignee: FANUC CORPORATION, Yamanashi (JP)

(21) Appl. No.: 16/188,932

(22) Filed: Nov. 13, 2018

(30) Foreign Application Priority Data
Nov. 15, 2017 (JP) 2017-219807

(51) Int. Cl. B23Q 1/62; B23Q 1/01; B23Q 5/10; B23Q 5/34

(52) U.S. Cl. CPC B23Q 1/62; B23Q 1/015; B23Q 1/017; B23Q 5/10; B23Q 5/34; B23Q 2716/08; B23Q 2240/002; B23Q 2701/02; B23Q 2705/104; B23Q 2705/145; B23Q 2220/002

(57) ABSTRACT

A machine tool includes: two Y-axis sliders arranged parallel to each other on the bed for allowing the saddle to move in the first direction; two X-axis sliders arranged parallel to each other on the saddle to move the table; and a controller. The controller, before controlling a first motor to move the saddle, controls a second motor to move the table so that the centroid position of a moving object assembly including the table and a loaded object placed on the table is positioned in a predetermined range including the center position between the two Y-axis sliders.

### CROSS-REFERENCE TO RELATED APPLICATION

This application is based upon and claims the benefit of priority from Japanese Patent Application No. 2017-219807 filed on Nov. 15, 2017, the contents of which are incorporated herein by reference.

### BACKGROUND OF THE INVENTION

### Field of the Invention

The present invention relates to a machine tool for machining a workpiece using tools and a control method for the machine tool.

### Description of the Related Art

Japanese Laid-Open Patent Publication No. 2014-161926 discloses a machine tool including a saddle that is supported by a first guide structure provided on a bed and can move relative to the bed in a first direction, and a table that is supported by a second guide structure provided on the saddle and can move relative to the saddle in a second direction perpendicular to the first direction.

### SUMMARY OF THE INVENTION

The saddle of the machine tool disclosed in Japanese Laid-Open Patent Publication No. 2014-161926 receives a load from objects including the table, sliders on the saddle and a workpiece placed on the table so as to be machined. Therefore, a large load is applied to the sliders on the bed as compared to the sliders on the saddle. For this reason, there is a concern that the life of the sliders on the bed becomes shorter than the sliders on the saddle.

The present invention has been devised in order to solve the above problem, and it is therefore an object of the present invention to provide a machine tool capable of improving the life of sliders on a bed as well as providing a control method of the machine tool.

According to the first aspect of the present invention, a machine tool including a saddle that moves relatively to a bed in a first direction and a table that moves relatively to the saddle in a second direction orthogonal to the first direction includes: two first sliders arranged parallel to each other on the bed and configured to allow the saddle to move in the first direction; a first motor configured to move the saddle; two second sliders arranged parallel to each other on the saddle and configured to allow the table to move in the second direction; a second motor configured to move the table; and a controller configured to control the first motor and the second motor. The controller, before controlling the first motor to move the saddle, is configured to control the second motor to move the table so that a centroid position of a moving object assembly including the table and a loaded object placed on the table is positioned in a predetermined range including a center position between the two first sliders.

The second aspect of the present invention resides in a control method for a machine tool including a saddle that moves relatively to a bed in a first direction and a table that moves relatively to the saddle in a second direction orthogonal to the first direction. The machine tool comprises: two first sliders arranged parallel to each other on the bed and configured to allow the saddle to move in the first direction; a first motor configured to move the saddle; two second sliders arranged parallel to each other on the saddle and configured to allow the table to move in the second direction; and a second motor configured to move the table. The control method includes: a table control step of controlling the second motor to move the table before moving the saddle so that a centroid position of a moving object assembly including the table and a loaded object placed on the table is positioned in a predetermined range including a center position between the two first sliders; and a saddle control step of controlling the first motor to move the saddle.

According to the present invention, it is possible to reduce the imbalance between the load acting on one of the first sliders and the load acting on the other and substantially equalize the two loads applied to the first sliders to each other. Thus, the present invention makes it possible to enhance the life of the slider parts on the bed.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic configuration diagram of a machine tool;

FIG. 2 is a schematic configuration diagram of a controller of the machine tool shown in FIG. 1;

FIG. 3 is a diagram showing a table state (1) of the machine tool shown in FIG. 1;

FIG. 4 is a diagram showing a table state (2) of the machine tool shown in FIG. 1; and

FIG. 5 is a flow chart of a control process executed when a table is moved in the Y-direction in the controller shown in FIG. 1.

### DESCRIPTION OF THE PREFERRED EMBODIMENTS

A machine tool and a method of controlling the machine tool according to the present invention will be detailed hereinbelow by describing preferred embodiments with reference to the accompanying drawings.

### [Configuration of Machine Tool]

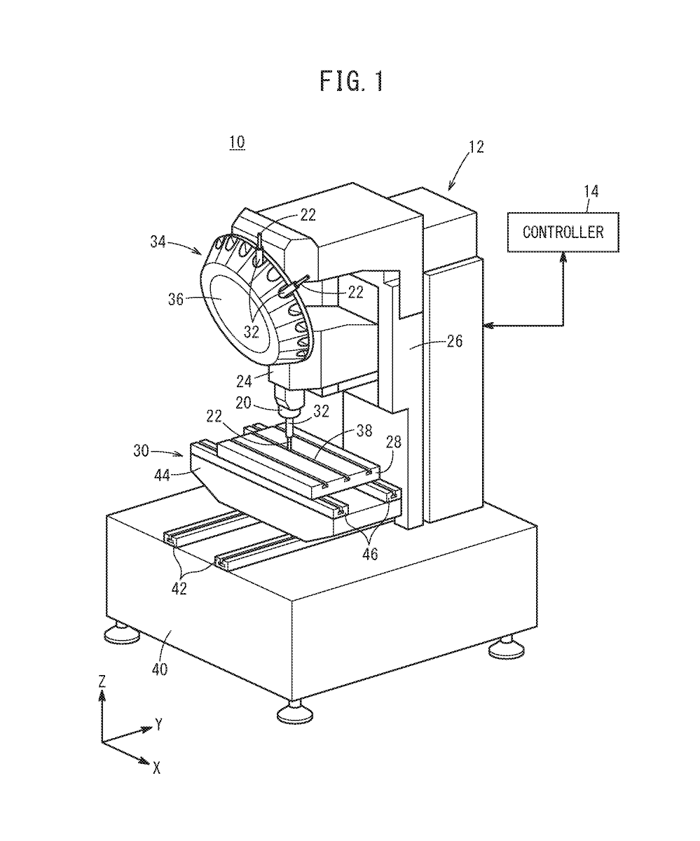

FIG. 1 is a schematic configuration diagram of a machine tool 10. The machine tool 10 includes a machine tool body 12 and a controller 14 for controlling the machine tool body 12. The machine tool body 12 and the controller 14 can exchange various kinds of information with each other by wirelessly or wired communication.

### [Configuration of Machine Tool Body]

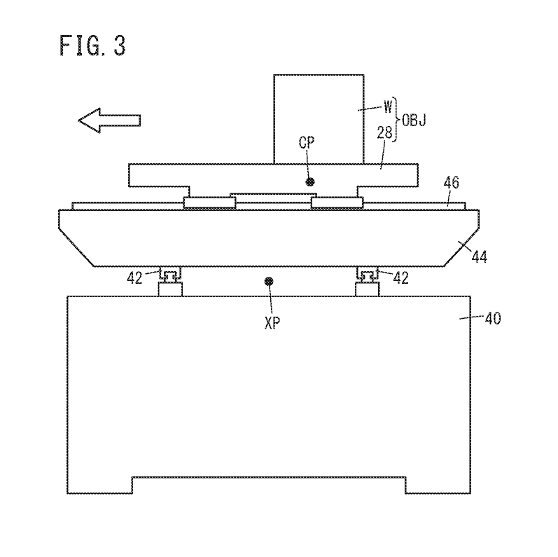

The machine tool body 12 has a spindle 20 and machines a workpiece W (see FIG. 3) using a tool 22 attached to the spindle 20. Other than the spindle 20, the machine tool body 12 further includes a spindle head 24, a column 26, a table 28 and a table driver 30.

The tool 22 is attached to the spindle 20 via a tool holder 32 which is detachably attached to the spindle 20. The tool holder 32 may have an anti-vibration mechanism such as a hydraulic chuck. The tool 22 attached to the spindle 20 via the tool holder 32 has its length oriented along the spindle 20, and the spindle 20 and the tool 22 rotate together. As the tool 22, for example, a spring necked tool, a drill, an end mill, a milling cutter and the like can be listed. The machine tool body 12 is configured as a machining center that can exchange the tool 22 attached to the spindle 20 by an automatic tool changer 34. The automatic tool changer 34 has a tool magazine 36 capable of accommodating (holding) multiple tools 22 each held by the tool holder 32.

The spindle head 24 rotatably supports the spindle 20 about a rotational axis parallel to the Z-direction (vertical direction), and has a spindle rotation motor for turning the spindle 20. The spindle rotation motor is used to control the phase (rotational position) of the spindle 20.

The column 26 is provided on a bed 40 and supports the spindle head 24 in a movable manner along the Z-direction. The column 26 incorporates, at least a spindle feeder for moving the spindle head 24 in the Z-direction and a spindle feed motor for driving the spindle feeder. As the spindle head 24 supported by the column 26 is moved in the Z-direction, the spindle 20 supported by the spindle head 24 also moves in the Z-direction.

The table 28 is capable of placing a workpiece W and the like, and is arranged under the spindle 20. On the upper surface of the table 28, a plurality of lock grooves 38 linearly extending in the X-direction are formed at intervals of a predetermined distance with respect to the Y-direction. The workpiece W may be fixed at a predetermined position on the table 28 via an unillustrated fixing jig. The fixing jig fixes the workpiece W on the upper surface of the table 28 using the lock grooves 38. The X-direction, the Y-direction and the Z-direction are orthogonal to each other.

The table driver 30 moves the table 28 in the X and Y directions and is supported by the bed 40. The table driver 30 has two Y-axis sliders 42, a saddle 44 and two X-axis sliders 46.

The two Y-axis sliders 42 are the first sliders for moving the saddle 44 in a first direction (the Y-direction). The two Y-axis sliders 42 linearly extend in the first direction (Y-direction), are arranged on the bed 40 in parallel to each other and spaced with respect to a second direction (the X-direction) orthogonal to the first direction (Y-direction). As the Y-axis sliders 42, for example, a rolling bearing using a rolling element or a sliding bearing without rolling elements can be used.

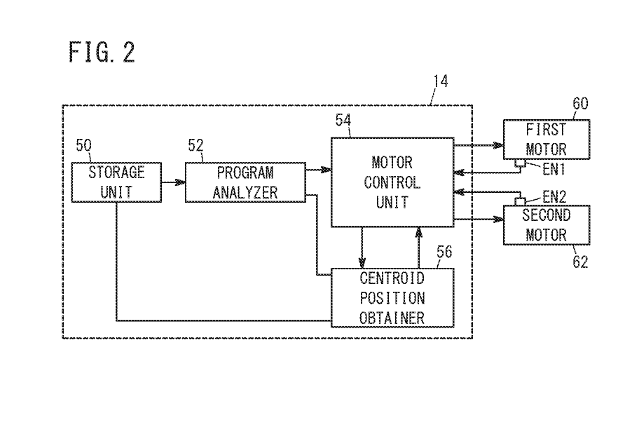

The saddle 44 is capable of holding the table 28 and is supported so as to be movable in the Y-direction relative to the bed 40 via the two Y-axis sliders 42. The saddle 44 is provided with a power transmission mechanism for the Y-axis. The Y-axis power transmission mechanism converts the rotatory force of a Y-axis motor 60 (see FIG. 2) into linear motion, including a ball screw arranged parallel to the Y-axis sliders 42 and a nut mating the ball screw. Therefore, as the Y-axis motor 60 is driven, the saddle 44 moves in the Y-direction. That is, the Y-axis motor 60 forms a first motor that moves the saddle 44. Note that as the saddle 44 moves in the Y-direction, the table 28 placed on the saddle 44 also moves in the Y-direction.

The two X-axis sliders 46 are the second sliders for moving the table 28 in the second direction (X-direction). The two X-axis sliders 46 linearly extending in the second direction (X-direction), are arranged on the saddle 44 in parallel to each other and spaced with respect to the first direction (Y-direction). As the X-axis slider 46, for example, a linear motion bearing such as a rolling bearing or a sliding bearing can be used.

The table 28 is supported so as to be movable in the X-direction relative to the saddle 44 via these two X-axis sliders 46. The table 28 is provided with a power transmission mechanism for the X-axis. The X-axis power transmission mechanism converts the rotary force of the X-axis motor 62 (see FIG. 2) into linear motion and includes a ball screw arranged parallel to the X-axis slider 46 and a nut mating the ball screw. Therefore, as the X-axis motor 62 is driven, the table 28 moves in the X-direction. That is, the X-axis motor 62 forms a second motor that moves the table 28.

With this configuration of the table driving section 30, the table 28 can be moved in the X and Y directions. Thanks to the motion of the table 28 in the X and Y directions and the motion of the spindle 20 in the Z-direction, the tool 22 attached to the spindle 20 can perform 3D machining on the workpiece W fixed to the table 28.

### [Configuration of Controller]

FIG. 2 is a schematic configuration diagram of the controller 14. The controller 14 includes a storage unit 50, a program analyzer 52, a motor control unit 54, and a centroid (center of gravity) position obtainer 56. Although not shown, the controller 14 includes an input unit for an operator to input information such as commands and settings, and a display unit for displaying necessary information to the operator.

The storage unit 50 stores a machining program and the like. The machining program is a program including information such as commands for machining the workpiece W, and is read out by the program analyzer 52. The program analyzer 52 analyzes the machining program read out from the storage unit 50 to impart the analysis result to the motor control unit 54.

The motor control unit 54 controls the Y-axis motor 60 and the X-axis motor 62 based on the analysis result from the program analyzer 52. The Y-axis motor 60 is provided with an encoder EN1 for detecting the rotational position of the Y-axis motor 60, and the X-axis motor 62 is provided with an encoder EN2 for detecting the rotational position of the X-axis motor 62. These positions are used by the motor control unit 54.

That is, the motor control unit 54 performs feedback control of the Y-axis motor 60 to move the saddle 44 in the Y-direction via the power transmission mechanism for the Y-axis, and performs feedback control of the X-axis motor 62 to move the table 28 in the X-direction via the power transmission mechanism for the X-axis.

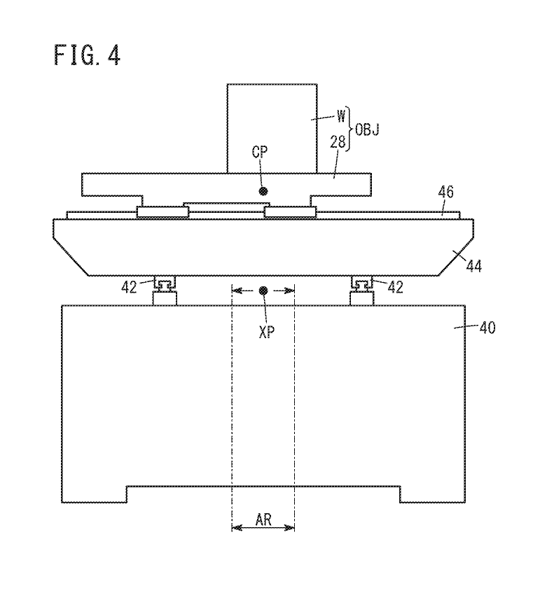

FIG. 3 shows a state (1) of the table 28, and FIG. 4 shows a state (2) of the table 28. As shown in FIG. 3, when the table 28 (saddle 44) is moved in the Y-direction, there occurs a situation in which the center of gravity (centroid position) CP of the objects to be moved (which will be referred to collectively as the moving object assembly OBJ) does not reside at the center position, designated at XP, between the two Y-axis sliders 42 with respect to the X-direction. The moving object assembly OBJ includes a table 28 and objects placed on the table 28. The loaded objects at least include the workpiece W. As described above, when the workpiece W is fixed on the table 28 by the fixing jig in cooperation with the lock grooves 38, the loaded objects include the workpiece W and the fixing jig.

When the table 28 (saddle 44) is moved in the Y-direction, if the centroid position CP of the moving object assembly OBJ is not located at the center position XP between the two Y-axis sliders 42 with respect to the X-direction, two loads, i.e., one applied on the left Y-axis slider 42 and the other applied to the right one are imbalanced. As a result, the deterioration of the Y-axis sliders 42 is accelerated so that the lives of the Y-axis sliders 42 are shortened.

To deal with this, when moving the saddle 44 by controlling the Y-axis motor 60, the motor control unit 54 controls the X-axis motor 62 to move the table 28 first before moving the saddle 44 so that the centroid position CP of the moving object assembly OBJ coincides with the center position XP between the two Y-axis sliders 42 with respect to the X-direction. As a result, as shown in FIG. 4 the moving object assembly OBJ is placed in a state where the centroid position CP of the moving object assembly OBJ is positioned on the center position XP between the two Y-axis sliders 42 with respect to the X-direction. Thus, the load applied to one of the two Y-axis sliders 42 and the load applied to the other are equalized without imbalance, so that even if the table 28 (saddle 44) is moved in the Y-direction, it is possible to suppress shortening of the lives of the Y-axis sliders 42.

The motor control unit 54 outputs the position of the table 28 to the centroid position obtainer 56 in order to acquire the centroid position CP of the moving object assembly OBJ. The centroid position obtainer 56 obtain the centroid position CP of the moving object assembly OBJ based on the position of the table 28, and outputs the acquired centroid position CP to the motor control unit 54.

As an obtaining method by the centroid position obtainer 56, for example, a method of calculating the centroid position CP of the moving object assembly OBJ can be considered. That is, the centroid position obtainer 56 calculates the centroid position CP of the moving object assembly OBJ based on the parameters stored in advance in the storage unit 50 and the position of the table 28. The parameters include the shape and mass of the table 28, the shapes and masses of the loaded objects, and the positions of placement of the loaded objects on the table 28.

### [Control Processing]

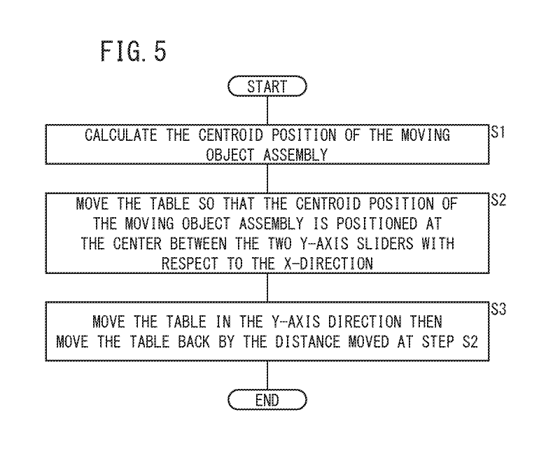

FIG. 5 is a diagram showing the flow of control processing performed by the controller 14 when the table 28 (saddle 44) is moved in the Y-direction. At step S1, the centroid position obtainer 56 calculates the centroid position CP of the moving object assembly OBJ based on the parameters stored in the storage unit 50 and the current position of the table 28, and the control proceeds to step S2.

At step S2, the motor control unit 54 controls the X-axis motor 62 to move the table 28 so that the centroid position CP of the moving object assembly OBJ is positioned at the center position XP between the two Y-axis sliders 42 with respect to the X-direction, and the control goes to step S3.

At step S3, the motor control unit 54 controls the Y-axis motor 60 to move the saddle 44 based on the analysis result of the machining program. With this movement, the table 28 placed on the saddle 44 moves in the Y-direction. Then, the motor control unit 54 controls the X-axis motor 62 so as to move the table 28 from the position where the table 28 has been moved in the Y-direction for the movement of the saddle 44, in the direction opposite to that of the movement at step S2, by the distance of the movement at step S2. As this control ends, the control processing terminates.

### [Operation and Effect]

As described above, in the present embodiment, when the table 28 on the saddle 44 is moved in the Y-direction by moving the saddle 44, the table 28 is moved so that the centroid position CP of the moving object assembly OBJ coincides with the center position XP between the two Y-axis sliders 42 with respect to the X-direction.

As a result, according to the present embodiment, when the table 28 is moved in the Y-direction, it is possible to prevent the load applied to one of the two Y-axis sliders 42 and the load applied to the other from becoming imbalanced, and equalize the two loads applied to the Y-axis sliders 42 to each other. Therefore, it is possible to extend the lives of the Y-axis sliders 42 compared to the case where the load applied to one of the two Y-axis sliders 42 and the load applied to the other are imbalanced.

### VARIATIONAL EXAMPLES

Although the above embodiment has been described as an example of the present invention, the technical scope of the present invention is not limited to the scope described in the above embodiment. It goes without saying that various modifications and improvements can be added to the above embodiment. It is also apparent from the scope of the claims that those with such modifications and improvements should be incorporated in the technical scope of the invention.

### Variational Example 1

In the above embodiment, the centroid position obtainer 56 calculates and obtains the centroid position CP of the moving object assembly OBJ, based on the shape and mass of the table 28, the shapes and masses of the loaded objects, the positions of placement of the loaded objects on the table 28, and the position of the table 28 when the X-axis motor 62 is controlled. However, when a database that associates the position of the centroid position CP of the moving object assembly OBJ with the position of the table 28 has been stored in a storage medium, the centroid position obtainer 56 may be configured to read and obtain the centroid position CP of the moving object assembly OBJ based on the database and the position of the table 28 when the X-axis motor 62 is controlled.

### Variational Example 2

In the above embodiment, the centroid position obtainer 56 acquires the centroid position CP of the moving object assembly OBJ, and the motor control unit 54 moves the table 28 so that the centroid position CP is positioned at the center position XP between the two Y-axis sliders 42 with respect to the X-direction. However, a machining program may include a set of instructions that causes the X-axis motor 62 to move the table 28 so that the centroid position CP of the moving object assembly OBJ can be positioned at the center position XP between the two Y-axis sliders 42 with respect to the X-direction, before controlling the Y-axis motor 60 to move the saddle 44. In this case, the centroid position obtainer 56 is omitted.

### Variational Example 3

In the above embodiment, the motor control unit 54 moves the table 28 based on the analysis result of the machining program so that the centroid position CP of the moving object assembly OBJ is positioned at the center position XP between the two Y-axis sliders 42 with respect to the X-direction. However, the motor control unit 54 may move the table 28 based on a command for operation to move the saddle 44 that is input through the input unit by the operator so that the centroid position CP of the moving object assembly OBJ can be positioned at the center position XP between the two Y-axis sliders 42 with respect to the X-direction.

### Variational Example 4

In the above embodiment, the centroid position CP of the moving object assembly OBJ is positioned at the center position XP between the two Y-axis sliders 42 with respect to the X-direction. However, the centroid position CP of the moving object assembly OBJ may be positioned at a point in a predetermined range AR (see FIG. 4) including the center position XP between the two Y-axis sliders 42 with respect to the X-direction. The predetermined range AR is defined as an area between a position shifted from the center position XP by a first predetermined distance toward one side of the two Y-axis sliders 42 and a position shifted from the center position XP by a second predetermined distance to the other side of the two Y-axis sliders 42. The first distance and the second distance are preferably equal to each other, but may be different. However, in view of equalizing the loads applied to the two Y-axis sliders 42, it is preferable that the centroid position CP of the moving object assembly OBJ is positioned at the center position XP between the two Y-axis sliders 42 with respect to the X-direction.

### Variational Example 5

The above modified examples 1 to 4 may be arbitrarily combined as long as no contradiction arises.

### [Technical Ideas]

Technical ideas that can be grasped from the above embodiment and Variational Examples 1 to 5 are described below.

### [First Technical Idea]

The machine tool (10) including the saddle (44) that moves relatively to the bed (40) in the first direction and the table (28) that moves relatively to the saddle (44) in the second direction orthogonal to the first direction includes: the two first sliders (42) arranged parallel to each other on the bed (40) and configured to allow the saddle (44) to move in the first direction; the first motor (60) configured to move the saddle (44); the two second sliders (46) arranged parallel to each other on the saddle (44) and configured to allow the table (28) to move in the second direction; the second motor (62) configured to move the table (28); and the controller (14) configured to control the first motor (60) and the second motor (62). The controller (14), before controlling the first motor (60) to move the saddle (44), is configured to control the second motor (62) to move the table (28) so that the centroid position (CP) of the moving object assembly (OBJ) including the table (28) and the loaded object placed on the table (28) is positioned in the predetermined range (AR) including the center position (XP) between the two first sliders (42).

As a result, it is possible to reduce the imbalance between the load applied to one of the two first sliders (42) and the load applied to the other, so that the loads applied to the two first sliders (42) can be substantially equalized. Therefore, it is possible to improve the lives of the slider components on the bed (40).

In the above machine tool (10), the controller (14) may be configured to control the second motor (62) to move the table (28) so that the centroid position (CP) of the moving object assembly (OBJ) is positioned at the center position (XP). This makes it possible to equalize the loads applied to the two first sliders (42) to each other, hence further enhance the lives of the slider components on the bed (40).

The above machine tool (10) may further include the centroid position obtainer (56) configured to acquire the centroid position (CP) of the moving object assembly (OBJ) based on the position of the table (28) when the second motor (62) is controlled. This configuration can also improve the lives of the slider components on the bed (40).

In the above machine tool (10), the centroid position obtainer (56) may be configured to calculate and acquire the centroid position (CP) of the moving object assembly (OBJ), based on the shape and mass of the table (28), the shape and mass of the loaded object, the position of placement of the loaded object on the table (28), and the position of the table (28) when the second motor (62) is controlled. This configuration makes it easy to cope with a change or the like of the loaded object placed on the table (28).

In the above machine tool (10), the centroid position obtainer (56) may be configured to read and acquire the centroid position (CP) of the moving object assembly (OBJ), from a database that relates the centroid position (CP) of the moving object assembly (OBJ) with the position of the table (28) and the position of the table (28) when the second motor (62) is controlled. This configuration makes it possible to replace the calculation process of the centroid position (CP) of the moving object assembly (OBJ) with a reference process, hence obtain the centroid position (CP) earlier thanks to elimination of the calculation process. Further, this is advantageous when a plurality of machine tools (10) are collectively managed.

### [Second Technical Idea]

In the control method for the machine tool (10) including the saddle (44) that moves relatively to the bed (40) in the first direction and the table (28) that moves relatively to the saddle (44) in the second direction orthogonal to the first direction, the machine tool (10) includes: the two first sliders (42) arranged parallel to each other on the bed (40) and configured to allow the saddle (44) to move in the first direction; the first motor (60) configured to move the saddle (44); the two second sliders (46) arranged parallel to each other on the saddle (44) and configured to allow the table (28) to move in the second direction; and the second motor (62) configured to move the table (28). The control method includes: the table control step (S2) of controlling the second motor (62) to move the table (28) before moving the saddle (44) so that the centroid position (CP) of the moving object assembly (OBJ) including the table (28) and the loaded object placed on the table (28) is positioned in the predetermined range (AR) including the center position (XP) between the two first sliders (42); and the saddle control step (S3) of controlling the first motor (60) to move the saddle (44).

As a result, it is possible to reduce the imbalance between the load applied to one of the two first sliders (42) and the load applied to the other, so that the loads applied to the two first sliders (42) can be substantially equalized. Therefore, it is possible to improve the lives of the slider components on the bed (40).

In the above control method for the machine tool (10), the table control step (S2) may control the second motor (62) to move the table (28) so that the centroid position (CP) of the moving object assembly (OBJ) is positioned at the center position (XP). This makes it possible to equalize the loads applied to the two first sliders (42) to each other, hence further enhance the lives of the slider components on the bed (40).

The above control method for the machine tool (10) may further include a centroid position obtaining step (S1) of acquiring the centroid position (CP) of the moving object assembly (OBJ) based on the position of the table (28) when the second motor (62) is controlled. This method can also improve the lives of the slider components on the bed (40).

In the above control method for the machine tool (10), the centroid position obtaining step (S1) may calculate and acquire the centroid position (CP) of the moving object assembly (OBJ), based on the shape and mass of the table (28), the shape and mass of the loaded object, the position of placement of the loaded object on the table (28), and the position of the table (28) when the second motor (62) is controlled. This method makes it easy to cope with a change or the like of the loaded object placed on the table (28).

In the above control method for the machine tool (10), the centroid position obtaining step (S1) may read and acquire the centroid position (CP) of the moving object assembly (OBJ), from a database that relates the centroid position (CP) of the moving object assembly (OBJ) with the position of the table (28), and the position of the table (28) when the second motor (62) is controlled. This method makes it possible to replace the calculation process of the centroid position (CP) of the moving object assembly (OBJ) with a reference process, hence obtain the centroid position (CP) earlier thanks to elimination of the calculation process. Further, this is advantageous when a plurality of machine tools (10) are collectively managed.

What is claimed is:

1. A machine tool including a saddle that moves relatively to a bed in a first direction and a table that moves relatively to the saddle in a second direction orthogonal to the first direction, comprising:
two first sliders arranged parallel to each other on the bed and configured to allow the saddle to move in the first direction;
a first motor configured to move the saddle;
two second sliders arranged parallel to each other on the saddle and configured to allow the table to move in the second direction;
a second motor configured to move the table; and
a controller configured to control the first motor and the second motor,
wherein the controller, before controlling the first motor to move the saddle, is configured to control the second motor to move the table so that a centroid position of a moving object assembly including the table and a loaded object placed on the table is positioned in a predetermined range including a center position between the two first sliders.

2. The machine tool according to claim 1, wherein the controller is configured to control the second motor to move the table so that the centroid position of the moving object assembly is positioned at the center position.

3. The machine tool according to claim 1, further comprising a centroid position obtainer configured to acquire the centroid position of the moving object assembly based on a position of the table when the second motor is controlled.

4. The machine tool according to claim 3, wherein the centroid position obtainer is configured to calculate and acquire the centroid position of the moving object assembly, based on a shape and mass of the table, a shape and mass of the loaded object, a position of placement of the loaded object on the table, and the position of the table when the second motor is controlled.

5. The machine tool according to claim 3, wherein the centroid position obtainer is configured to read and acquire the centroid position of the moving object assembly, from a database that relates the centroid position of the moving object assembly with a position of the table, and the position of the table when the second motor is controlled.

6. A control method for a machine tool including a saddle that moves relatively to a bed in a first direction and a table that moves relatively to the saddle in a second direction orthogonal to the first direction, wherein the machine tool comprises:
two first sliders arranged parallel to each other on the bed and configured to allow the saddle to move in the first direction;
a first motor configured to move the saddle;
two second sliders arranged parallel to each other on the saddle and configured to allow the table to move in the second direction; and
a second motor configured to move the table,
the control method comprising:
a table control step of controlling the second motor to move the table before moving the saddle so that a centroid position of a moving object assembly including the table and a loaded object placed on the table is positioned in a predetermined range including a center position between the two first sliders; and
a saddle control step of controlling the first motor to move the saddle.

7. The control method for the machine tool according to claim 6, wherein the table control step controls the second motor to move the table so that the centroid position of the moving object assembly is positioned at the center position.

8. The control method for the machine tool according to claim 6, further comprising a centroid position obtaining step of acquiring the centroid position of the moving object assembly based on a position of the table when the second motor is controlled.

9. The control method for the machine tool according to claim 8, wherein the centroid position obtaining step calculates and acquires the centroid position of the moving object assembly, based on a shape and mass of the table, a shape and mass of the loaded object, a position of placement of the loaded object on the table, and the position of the table when the second motor is controlled.

10. The control method for the machine tool according to claim 8, wherein the centroid position obtaining step reads and acquires the centroid position of the moving object assembly, from a database that relates the centroid position of the moving object assembly with a position of the table, and the position of the table when the second motor is controlled.
